(19) United States
(12) Patent Application Publication
(10) Pub. No.: US 2010/0325689 A1
(43) Pub. Date: Dec. 23, 2010

(54) USE AUTHORITY ATTACHING DEVICE AND COMPUTER READABLE MEDIUM

(75) Inventor: Yoshikazu KAWAI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/626,123

(22) Filed: Nov. 25, 2009

(30) Foreign Application Priority Data
Jun. 18, 2009 (JP) 2009-145064

(51) Int. Cl. G06F 21/00; G06F 7/04

(52) U.S. Cl. 726/1; 726/30

(57) ABSTRACT

A use authority attaching device includes: a storing unit that stores use authority information corresponding to each of stamped images of various forms; a detecting unit that detects a stamped image from a document image obtained by reading a stamped paper document; and a storage control unit that specifies use authority information corresponding to the stamped image detected by the detecting unit from the storing unit and stores an electronic document corresponding to the document image in a predetermined saving unit, in association with the specified use authority information under control.

### CROSS-REFERENCE TO RELATED APPLICATIONS

This application is based on and claims priority under 35 USC 119 from Japanese Patent Application No. 2009-145064 filed Jun. 18, 2009.

### BACKGROUND

1. Technical Field

The present invention relates to a use authority attaching device and a computer readable medium.

2. Related Art

In order to avoid an inappropriate use of electronic document, such a method is widely performed that the information for defining use authority of authorized users and groups for the electronic document is previously created, hence to control the use of the electronic document, according to the information. The information for defining the use authority is called as access control information (or list) and security policy (hereinafter, totally referred to as “security policy”). Also, there is a system for managing the security policy intensively in a server on the network. In the system of this kind, when a user issues an operation request for the electronic document through an information processing device on the network, the information processing device asks the server whether the user is allowed to do the operation of the request and determines whether or not to permit the request, according to the inquiry.

In order to computerize a paper document, store it, and manage the use authority based on a security policy, it is necessary to attach the security policy to the document.

### SUMMARY

According to an aspect of the present invention, there is provided a use authority attaching device including: a storing unit that stores use authority information corresponding to each of stamped images of various forms; a detecting unit that detects a stamped image from a document image obtained by reading a stamped paper document; and a storage control unit that specifies use authority information corresponding to the stamped image detected by the detecting unit from the storing unit and stores an electronic document corresponding to the document image in a predetermined saving unit, in association with the specified use authority information under control.

### BRIEF DESCRIPTION OF THE DRAWINGS

Exemplary embodiments of the present invention will be described in detail based on the following figures, wherein:

FIG. 1 is a view for use in describing an example of the structure of a system according to an exemplary embodiment.

FIG. 2 is a functional block diagram showing a structural example of a security policy management server according to the exemplary embodiment.

FIG. 3 is a view showing an example of security policy definition information managed by the policy managing unit.

FIG. 4 is a view showing an example of stamp definition information.

FIG. 5 is a view for use in describing a flow of the processing in the system.

### DETAILED DESCRIPTION

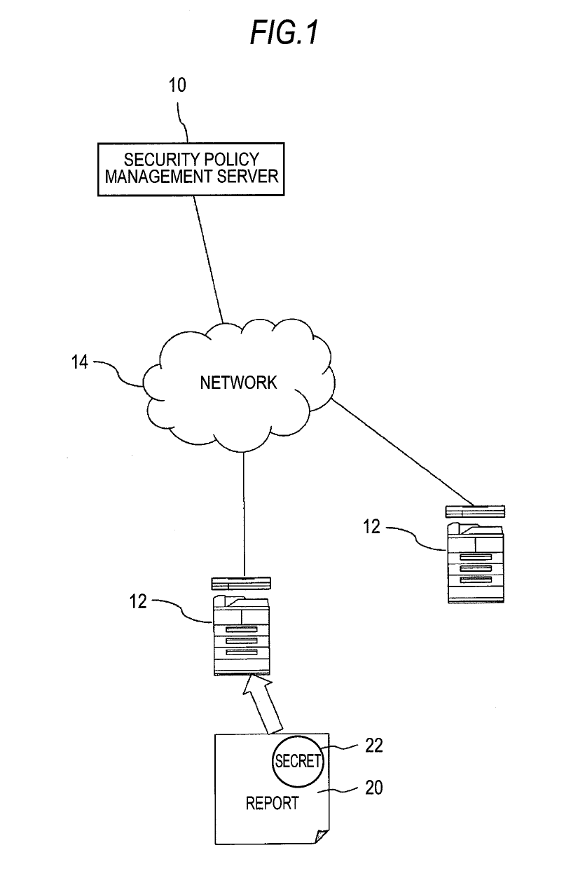

An example of a system structure according to an exemplary embodiment will be described with reference to FIG. 1. The system includes a security policy management server 10 and a reading device 12 mutually connected with each other through a network 14 such as a local area network.

The security policy management server 10 is a device for attaching (setting) a security policy to the electronic document to be registered. The reading device 12 is a device for reading out the image of a paper document. As a concrete example of the reading device 12, for example, there are a scanner, a digital copier, a digital multifunction device (device having functions of a printer, a scanner, and a copier).

In the exemplary embodiment, the reading device 12 computerizes a paper document 20 and registers the resultant electronic document into a repository of the security policy management server 10. The security policy management server 10 attaches the security policy to the electronic document to be registered.

This security policy includes use authority information (access control information) for defining what kind of use authority (or operation authority) each user or each user group (group consisting of a plurality of users) has for the electronic document.

In the exemplary embodiment, when a user wants to attach a security policy to the document 20 to be computerized and registered, the user puts a previously registered stamp on the document 20 so that the reading device 12 reads it. The respective security policies are assigned to the respective stamped impressions 22 (for example, depending on color, shape, and their combination). The security policy management server 10 receives the electronic document as the reading result, detects the image of the stamped impression 22 from the document, and assigns the security policy corresponding to the impression 22 to the electronic document.

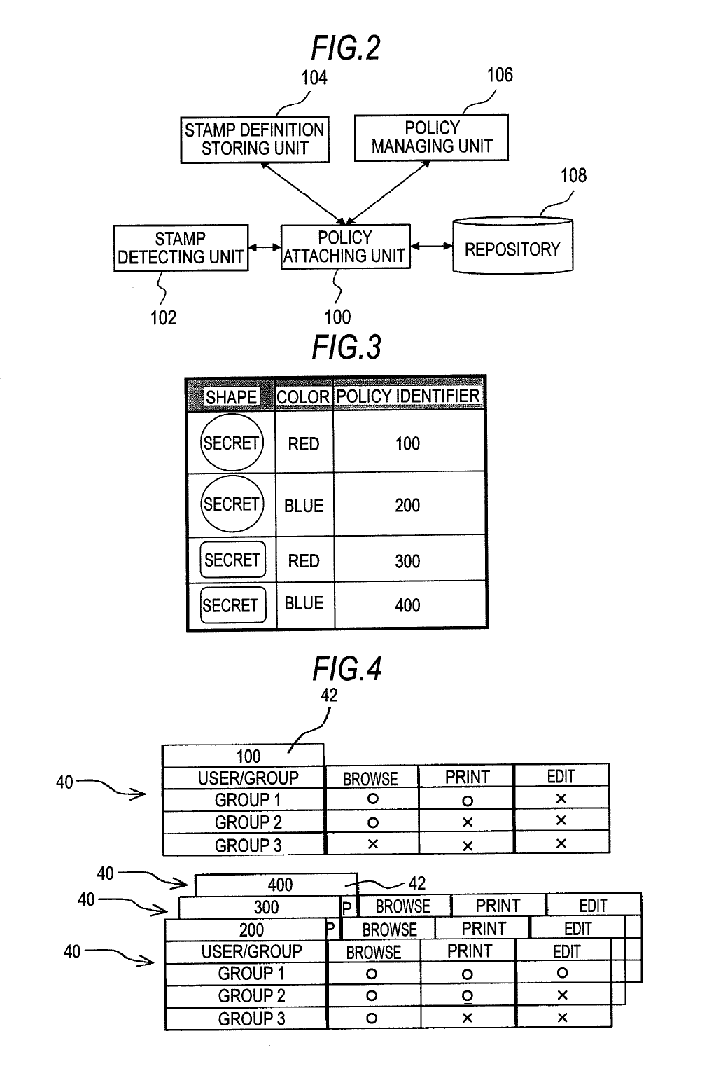

FIG. 2 shows a structural example of the security policy management server 10. In this example, the security policy management server 10 includes a policy attaching unit 100, a stamp detecting unit 102, a stamp definition storing unit 104, a policy managing unit 106, and a repository 108.

The policy attaching unit 100 attaches a security policy to an electronic document to be registered which is transmitted together with a registration request from the reading device 12 and a client device such as a personal computer on the network 14.

The stamp detecting unit 102 detects the image of a stamped impression from the image of the electronic document to be registered. The image to be detected is the stamped impression previously registered in the security policy management server 10.

The stamp definition storing unit 104 stores the form/forms of one or more stamped impressions and the information (hereinafter referred to as “stamp definition”) about a relationship between each impression and each security policy. FIG. 3 shows one example of the stamp definition stored in the stamp definition storing unit 104. In the example, the stamped impressions are represented by a combination of shape and color (the image formed on paper as the result of stamping), where four kinds of stamped impression are defined by the combinations of two shapes and two colors (red and blue). The identification information (“policy identifier”) corresponding to each security policy is registered in each stamped impression form.

An organization using the system of the exemplary embodiment has to decide the types of stamps (for example, the types of the impression forms) used for specifying the respective security policies and when the respective security policies are distinguished by the color of the impression, it has to decide the color of the stamp ink. Further, it has to decide the correspondence between the individual impression forms represented by the shapes and the colors and the respective security policies. It registers the above correspondence relationship between the impression forms and the security policies into the stamp definition storing unit 104. The impressions are sorted by the shape and color and managed separately in this figure; it is shown just as an example. Instead, for example, a colored stamped impression image that is a real stamping result may be registered as it is as the impression form and a policy identifier corresponding to this may be accordingly registered.

For example, a stamp a user wants to register is stamped in his or her desired color ink on the predetermined registration paper, which stamped paper may be read out by the reading device 12, in order to register the new impression form. At the same time, the user specifies a security policy corresponding to the impression form. For this processing, the security policy management server 10 supplies a list screen of the existing security policies (for example, to the reading device 12) and the registrant may select a desired policy of the user from the list. Alternatively, a user interface (UI) screen for creating a new security policy, for example, a screen including the UI for selecting types of operation authority and a user and a group having this authority may be supplied from the security policy management server 10 (for example, to the reading device 12). In this case, a policy created through the UI screen is registered in the policy managing unit 106 and the impression form read out from the registration paper is registered in the stamp definition storing unit 104 associated with the policy.

The policy managing unit 106 stores the definition contents (hereinafter referred to as “the policy definition”) of the individual security policies. An example of the policy definitions stored in the policy managing unit 106 is shown in FIG. 4. In this example, each of the policy definitions 40 of the respective security policies includes a policy identifier 42 and information of use authority supplied to each user or each user group. The information of use authority includes information about whether or not each user or group is allowed to have the authority of each item in every item of the use authority (for example, the right to see, copy, edit). In FIG. 4, a circle means the permission of the item and a cross means the prohibition of the item. The policy definitions shown in FIG. 4 are taken just as an example. As far as the policy definition contains the information for controlling the use of the electronic document from a user side, it may take whatever data structure.

The repository 108 is a database for registering electronic documents transmitted from a client device such as the reading device 12. In the example, an electronic document itself and information of a security policy assigned to the electronic document (or the information specifying the security policy, for example, a policy identifier) are correspondingly stored into the repository 108.

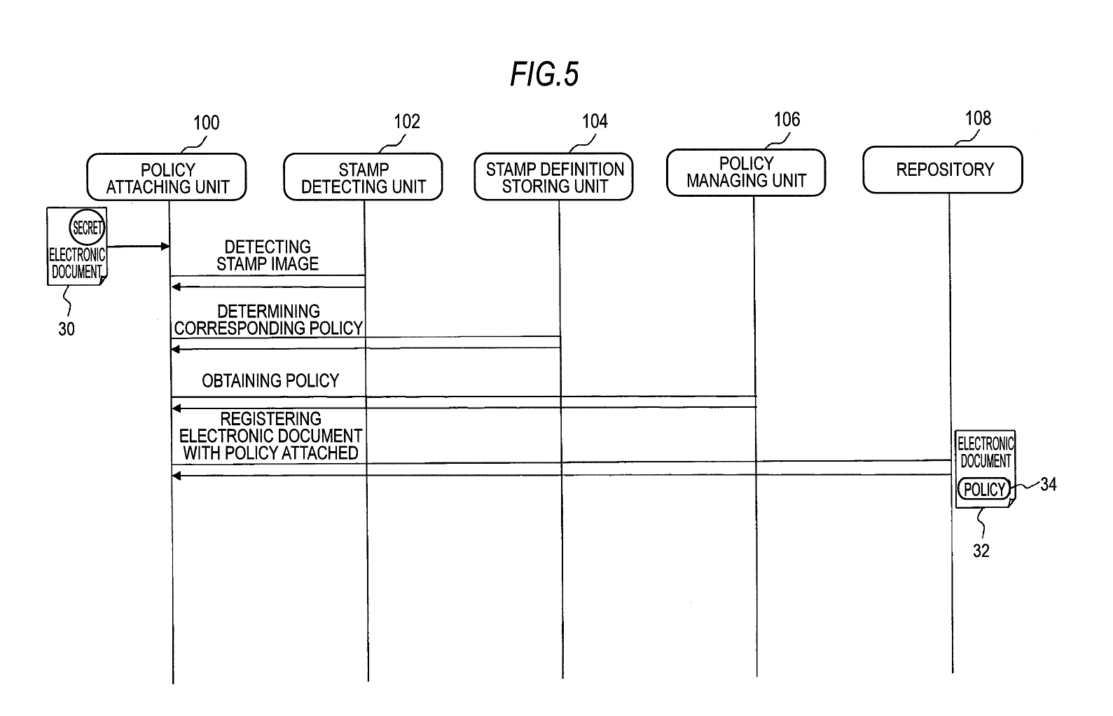

Next, the flow of the processing for computerizing a paper document and registering it in the repository 108 correspondingly to a security policy will be described with reference to FIG. 5.

At first, when a user wants to computerize a paper document with a security policy attached, the user selects a stamp corresponding to the security policy and puts the stamp on the paper document. When the security policies are distinguished by the color of the stamped impression, the user stamps it with an ink pad of the color corresponding to the above security policy. The user sets the stamped paper document on the reading device 12 and operates the user interface of the reading device 12 to make an instruction to carry out the processing for registering the paper document into the repository 108. The reading device 12 reads out the set paper document, creates an electronic document 30 of a predetermined file format (for example, PDF) including the image of the reading result, and transmits it to the security policy management server 10 together with the registration request. The electronic document 30 may include only the image data of the reading result, or it may include the attribute information such as reading date and ID of a user making this operation, in addition to the image data. In the latter case, naturally, one or whole of the attribute values of the electronic document 30 may be set by the security policy management server 10. When the impression forms are distinguished by the color, the reading device 12 reads the paper document in color.

In the security policy management server 10 receiving the target electronic document 30 together with a registration request, the policy attaching unit 100 asks the stamp detecting unit 102 to detect the stamped impression image from the electronic document 30. The stamp detecting unit 102 searches the image of the impression form registered in the stamp definition storing unit 104 from the image in the electronic document 30. For the above searching, template matching can be performed, for example, with the images of the respective impression forms registered in the stamp definition storing unit 104 as templates.

In this way, when an image matching some of the registered impression forms is found from the electronic document 30, the policy attaching unit 100 obtains the policy identifier corresponding to the matched impression form from the stamp definition storing unit 104. The policy attaching unit 100 obtains the data of the policy definition 40 corresponding to the obtained policy identifier from the policy managing unit 106 and embeds the obtained policy definition 40 in the electronic document 30 as the security attribute information. Thus, the electronic document 32 with the security policy 34 set there is created. The policy attaching unit 100 registers the electronic document 32 into the repository 108.

In this example, the contents of the attached security policy (policy definition) are stored in a file of the electronic document 32; however, it is taken just as an example. Instead, the policy identifier may be set as the attribute of the electronic document 32 and when a control according to the policy becomes necessary, the identifier may be used to obtain the policy contents from the policy managing unit 106. Alternatively, instead of making the electronic document 32 have the contents of a policy and an identifier, correspondence relationship between the both may be created as the other correspondence information and stored in the repository 108. In order to attach a security policy to the electronic document, any method will do as far as it can determine the correspondence relationship between the electronic document and the security policy.

The use control when a user makes an operation request for the electronic document with the security policy attached is the same as the conventional one. For example, the security policy management server 10 may check whether the operation request from the user is permitted or not, according to the policy definition corresponding to the electronic document. In the method of embedding the policy definition in a file of the electronic document 32, the electronic document 32 may include a program itself for checking the possibility of each operation according to the policy definition.

According to this, a security policy corresponding to an impression form stamped on a paper document by a person who tries to register it is associated to the computerized document in the exemplary embodiment. Namely, in this exemplary embodiment, a security policy attached to the electronic document is determined regardless of the information already printed on the paper document such as a title. Further, in this exemplary embodiment, when a paper document itself with a stamp put there is stored, the security policy applied to the paper document can be found from the stamped impression.

The above mentioned exemplary embodiment is taken just as an example. For example, in the above mentioned exemplary embodiment, the repository 108 with the electronic document registered is set within the security policy management server 10; however, the repository 108 may be set instead in another computer on the network 14. The policy managing unit 106 holding and managing the policy definitions may be installed in another computer different from the policy attaching unit 100.

The security policy management server 10 as mentioned above or a device supplying each function in the server is realized by making a general purpose computer execute a program performing the above mentioned processing. Here, the computer has a circuit structure including, for example, a microprocessor such as CPU, a memory (primary storage) such as a random access memory (RAM) and a read only memory (ROM), an HDD (hard disk drive) connected through an HDD controller, and various I/O (input and output) interfaces, as the hardware, which are connected to each other through a bus. A network interface for connecting to a network such as a local area network may be connected to the bus. A disk drive for reading or writing data from or in a portable disk storing medium such as CD and DVD and a memory reader and writer for reading or writing data from or in a non-volatile portable storing medium of various standards such as a flash memory may be connected to the bus, for example through an I/O interface. A program with the contents of each processing of the above mentioned functional modules described there is stored in a fixed storing device such as a hard disk drive and installed into a computer through the storing medium such as CD and DVD or through a communication means such as a network. The installed program is read out by the RAM and carried out by the microprocessor such as CPU, thereby realizing the functions of the above mentioned device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the skilled in the art to understand the invention for various embodiments and with the various modifications as are suited to the particular use contemplated. It is intended that the scope of the invention be defined by the following claims and their equivalents.

What is claimed is:

1. A use authority attaching device, comprising:
a storing unit that stores use authority information corresponding to each of stamped images of various forms;
a detecting unit that detects a stamped image from a document image obtained by reading a stamped paper document; and
a storage control unit that specifies use authority information corresponding to the stamped image detected by the detecting unit from the storing unit and stores an electronic document corresponding to the document image in a predetermined saving unit, in association with the specified use authority information under control.

2. The use authority attaching device according to claim 1, wherein
the form of the stamped image is represented by color or shape or a combination of color and shape of the stamped image.

3. A computer readable medium storing a program causing a computer to execute a process for attaching use authority, the process comprising:
storing use authority information corresponding to each of stamped images of various forms;
detecting a stamped image from a document image obtained by reading a stamped paper document; and
specifying use authority information corresponding to the stamped image detected by the detecting unit from the storing unit, and storing an electronic document corresponding to the document image in a predetermined saving unit, in association with the specified use authority information under control.
